(19) United States
(12) Patent Application Publication
(10) Pub. No.: US 2021/0284179 A1
(43) Pub. Date: Sep. 16, 2021

(54) VEHICLE HEALTH CALIBRATION

(71) Applicant: Ford Global Technologies, LLC, Dearborn, MI (US)

(72) Inventors: Brendan Diamond, Grosse Pointe, MI (US); Erik J. Christen, Royal Oak, MI (US); Yuan Zhang, Southgate, MI (US); Walter William Schwartz, Grosse Pointe Woods, MI (US); Nayaz Khalid Ahmed, Canton, MI (US); Jeff R. Grimes, Canton, MI (US); Heinrich Enslin, Dearborn, MI (US)

(73) Assignee: Ford Global Technologies, LLC, Dearborn, MI (US)

(21) Appl. No.: 16/815,307

(22) Filed: Mar. 11, 2020

(51) Int. Cl. B60W 50/00; G06N 3/04; G07C 5/08

(52) U.S. Cl. CPC B60W 50/00; G06N 3/0445; B60W 2050/0088; G06N 3/0454; G07C 5/085; G06N 3/0427

(57) ABSTRACT

A computer, including a processor and a memory, the memory including instructions to be executed by the processor to predict failures for each of a plurality of vehicle components by processing vehicle data with one or more recurrent neural networks, wherein vehicle data includes engineering test data, vehicle control data, vehicle service data, and vehicle environment data and wherein predicting the respective failures includes determining a remaining useful life for each of the plurality of vehicle components. The instructions can include further instructions to determine a vehicle optimization strategy by optimizing remaining useful life for one or more of the plurality of vehicle components to avoid the vehicle component failure and download the vehicle optimization strategy to a vehicle.

### BACKGROUND

Vehicles can be equipped with computing devices, networks, sensors and controllers to acquire data regarding the vehicle's environment and to operate the vehicle based on the data. Vehicle sensors can provide large volumes of data concerning vehicle operation over a vehicle's lifetime. However, it is challenging and problematic to receive and process large volumes of vehicle sensor data over extended time periods, and/or to combine various sources of data regarding vehicle operation.

### BRIEF DESCRIPTION OF THE DRAWINGS

FIG. 1 is a diagram of an example traffic infrastructure system.

FIG. 2 is a diagram of an example long short-term memory-recurrent neural network.

FIG. 3 is a diagram of an example hierarchical recurrent neural network.

FIG. 4 is a diagram of another example hierarchical recurrent neural network.

FIG. 5 is a diagram of an example vehicle optimization strategy.

FIG. 6 is a flowchart diagram of an example process to determine and download a vehicle optimization strategy.

### DETAILED DESCRIPTION

Vehicles can be equipped to operate in both autonomous and occupant piloted mode. By a semi- or fully-autonomous mode, we mean a mode of operation wherein a vehicle can be piloted partly or entirely by a computing device as part of a system having sensors and controllers. The vehicle can be occupied or unoccupied, but in either case the vehicle can be partly or completely piloted without assistance of an occupant. For purposes of this disclosure, an autonomous mode is defined as one in which each of vehicle propulsion (e.g., via a powertrain including an internal combustion engine and/or electric motor), braking, and steering are controlled by one or more vehicle computers; in a semi-autonomous mode the vehicle computer(s) control(s) one or two of vehicle propulsion, braking, and steering. In a non-autonomous mode, none of these are controlled by a computer.

Techniques discussed herein include a computing device in a traffic infrastructure system programmed to determine data regarding the estimated health of a vehicle, where determining a vehicle's estimated health includes determining an estimated remaining useful life of components included in a vehicle using a plurality of interconnected recurrent neural networks to process time series data to produce state of health estimates for a vehicle including the vehicle's systems, subsystems and components. The plurality of interconnected recurrent neural networks include memory, which permits the plurality of interconnected recurrent neural networks to accurately determine a vehicle's state of health by determining relationships between multiple vehicle data items corresponding to seemingly unrelated events separated by various amounts of time. The plurality of interconnected recurrent neural networks can determine these relationships as a result of training the interconnected recurrent neural networks based on empirical observations of a plurality of vehicle's states of health and corresponding vehicle data. Training the interconnected recurrent neural networks based on empirical observations can also permit the plurality of interconnected recurrent neural networks to determine which portions of vehicle data to use in estimating the state of health of a vehicle thereby reducing the amount of network data traffic required to estimate the state of health of a vehicle. Training the interconnected recurrent neural networks in this fashion can also permit optimal configuration of the recurrent neural networks by eliminating irrelevant and redundant recurrent neural networks and reducing the processing to minimal processing required to reach the vehicle state of health results based on training.

Data regarding the estimated health of a vehicle determined by the interconnected recurrent neural networks can be combined with data regarding operation of the vehicle to determine an optimization strategy to maximize the estimated remaining useful life of the vehicle. The state of health estimates can be combined with vehicle operation data to determine a vehicle optimization strategy, where a vehicle optimization strategy can be downloaded to the vehicle or determined by a computing device in the vehicle to direct the vehicle to maximize the remaining useful life of vehicle components. For example, a computing device in a vehicle can maximize the remaining useful life of vehicle components by, when a choice between vehicle components is available, operating the vehicle using the vehicle component with the most remaining useful life.

Disclosed herein is method including predicting one or more failures for each of a plurality of vehicle components by processing vehicle data with one or more recurrent neural networks, wherein the vehicle data includes engineering test data, vehicle control data, vehicle service data, and vehicle environmental data and wherein predicting the respective failures includes determining a remaining useful life for each of the plurality of vehicle components, determining a vehicle optimization strategy by optimizing the remaining useful life for one or more of the plurality of vehicle components to avoid the respective failures, and downloading the vehicle optimization strategy to a vehicle. The vehicle data can be processed by uploading the vehicle control data and the vehicle environmental data to a cloud-based computing device with a computing device included in the vehicle. The vehicle optimization strategy can include determining the vehicle control data that avoids the failures by operating the vehicle based on one or more of the plurality of vehicle components with the most remaining useful life. The vehicle can be operated based on the vehicle components with the most remaining useful life including one or more of selecting battery cells with the fewest charge/discharge cycles for operating the vehicle or, when two or more transmission gears can be selected for operating the vehicle, selecting the transmission gear with the least wear.

The vehicle can be operated based on vehicle optimization strategy by downloading the vehicle control data from a cloud-based computing device. The engineering test data can include component wear data based on empirical testing of one or more of the plurality of vehicle components. The vehicle service data can include data regarding repairs and routine maintenance performed on the vehicle including measurements of one or more of vehicle component wear and vehicle component replacement. The measurements of the vehicle component wear can include vehicle fluid analysis, including vehicle oil analysis. The vehicle control data can include operating data for one or more of the vehicle components acquired by a computing device included in the vehicle, wherein the operating data includes data acquired by sensors included in the vehicle. The vehicle environmental data can include data regarding vehicle operating conditions acquired by a computing device included in the vehicle, wherein vehicle operating conditions includes data acquired by sensor included in the vehicle. The one or more recurrent neural networks can include a tree structure of recurrent neural networks, wherein vehicle component subsystems each have a separate recurrent neural network that calculates the remaining useful life for each vehicle component subsystem. Vehicle environmental data can include temperature, humidity and precipitation. The recurrent neural network can be a long short term memory neural network. Operating the vehicle can be based on the downloaded vehicle optimization strategy.

Further disclosed is a computer readable medium, storing program instructions for executing some or all of the above method steps. Further disclosed is a computer programmed for executing some or all of the above method steps, including a computer apparatus, programmed to predict one or more failures for each of a plurality of vehicle components by processing vehicle data with one or more recurrent neural networks, wherein the vehicle data includes engineering test data, vehicle control data, vehicle service data, and vehicle environmental data and wherein predicting the respective failures includes determining a remaining useful life for each of the plurality of vehicle components, determine a vehicle optimization strategy by optimizing the remaining useful life for one or more of the plurality of vehicle components to avoid the respective failures, and download the vehicle optimization strategy to a vehicle. The vehicle data can be processed by uploading the vehicle control data and the vehicle environmental data to a cloud-based computing device with a computing device included in the vehicle. The vehicle optimization strategy can include determining the vehicle control data that avoids the failures by operating the vehicle based on one or more of the plurality of vehicle components with the most remaining useful life. The vehicle can be operated based on the vehicle components with the most remaining useful life including one or more of selecting battery cells with the fewest charge/discharge cycles for operating the vehicle or, when two or more transmission gears can be selected for operating the vehicle, selecting the transmission gear with the least wear.

The computer can be further programmed to operate the vehicle based on vehicle optimization strategy by downloading the vehicle control data from a cloud-based computing device. The engineering test data can include component wear data based on empirical testing of one or more of the plurality of vehicle components. The vehicle service data can include data regarding repairs and routine maintenance performed on the vehicle including measurements of one or more of vehicle component wear and vehicle component replacement. The measurements of the vehicle component wear can include vehicle fluid analysis, including vehicle oil analysis. The vehicle control data can include operating data for one or more of the vehicle components acquired by a computing device included in the vehicle, wherein the operating data includes data acquired by sensors included in the vehicle. The vehicle environmental data can include data regarding vehicle operating conditions acquired by a computing device included in the vehicle, wherein vehicle operating conditions includes data acquired by sensor included in the vehicle. The one or more recurrent neural networks can include a tree structure of recurrent neural networks, wherein vehicle component subsystems each have a separate recurrent neural network that calculates the remaining useful life for each vehicle component subsystem. Vehicle environmental data can include temperature, humidity and precipitation. The recurrent neural network can be a long short term memory neural network. Operating the vehicle can be based on the downloaded vehicle optimization strategy.

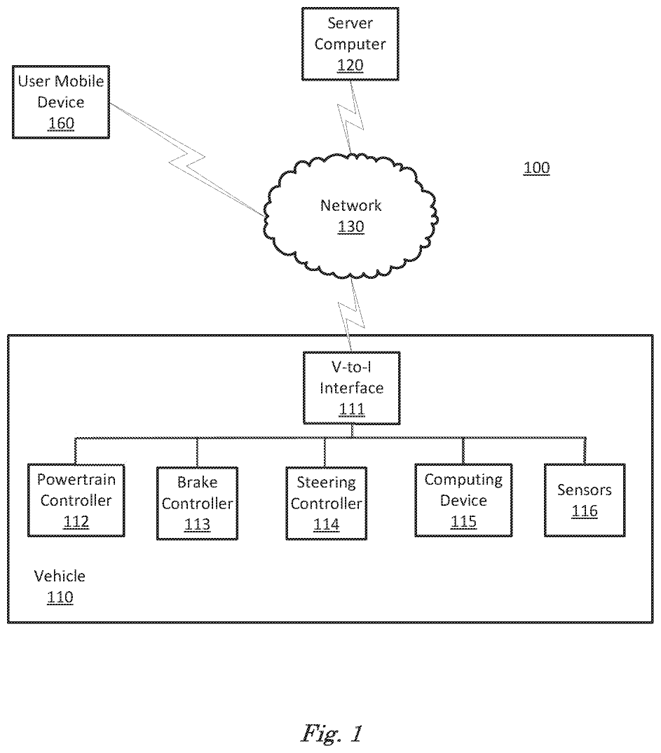

FIG. 1 is a diagram of a traffic infrastructure system 100 that includes a vehicle 110 operable in autonomous (“autonomous” by itself in this disclosure means “fully autonomous”), semi-autonomous, and occupant piloted (also referred to as non-autonomous) mode. One or more vehicle 110 computing devices 115 can receive data regarding the operation of the vehicle 110 from sensors 116. The computing device 115 may operate the vehicle 110 in an autonomous mode, a semi-autonomous mode, or a non-autonomous mode.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, e.g., via a vehicle communications bus as described further below, more than one computing devices, e.g., controllers or the like included in the vehicle 110 for monitoring and/or controlling various vehicle components, e.g., a powertrain controller 112, a brake controller 113, a steering controller 114, etc. The computing device 115 is generally arranged for communications on a vehicle communication network, e.g., including a bus in the vehicle 110 such as a controller area network (CAN) or the like; the vehicle 110 network can additionally or alternatively include wired or wireless communication mechanisms such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V-to-I) interface 111 with a remote server computer 120, e.g., a cloud server, via a network 130, which, as described below, includes hardware, firmware, and software that permits computing device 115 to communicate with a remote server computer 120 via a network 130 such as wireless Internet (WI-FI®)) or cellular networks. V-to-I interface 111 may accordingly include processors, memory, transceivers, etc., configured to utilize various wired and/or wireless networking technologies, e.g., cellular, BLUETOOTH® and wired and/or wireless packet networks. Computing device 115 may be configured for communicating with other vehicles 110 through V-to-I interface 111 using vehicle-to-vehicle (V-to-V) networks, e.g., according to Dedicated Short Range Communications (DSRC) and/or the like, e.g., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V-to-I) interface 111 to a server computer 120 or user mobile device 160. Server computer 120 can also function as a computing device 115 included in an edge computing node, where an edge computing node is a computing device 115 that acquires sensor data and communicates with vehicles 110 in a local portion of one or more of a roadway, parking lot or parking structure, etc.

As already mentioned, generally included in instructions stored in the memory and executable by the processor of the computing device 115 is programming for operating one or more vehicle 110 components, e.g., braking, steering, propulsion, etc., without intervention of a human operator. Using data received in the computing device 115, e.g., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve safe and efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and/or control a specific vehicle subsystem. Examples include a powertrain controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more powertrain controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously, for example.

The vehicle 110 is generally a land-based vehicle 110 capable of autonomous and/or semi-autonomous operation and having three or more wheels, e.g., a passenger car, light truck, etc. The vehicle 110 includes one or more sensors 116, the V-to-I interface 111, the computing device 115 and one or more controllers 112, 113, 114. The sensors 116 may collect data related to the vehicle 110 and the environment in which the vehicle 110 is operating. By way of example, and not limitation, sensors 116 may include, e.g., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, e.g., sensors 116 can detect phenomena such as weather conditions (precipitation, external ambient temperature, etc.), the grade of a road, the location of a road (e.g., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

The system 100 architecture illustrated in FIG. 1 with a computing device 115 in a vehicle communicating with a server computer 120 via a network 130, where the server computer 120 is in communication with a plurality of interconnected recurrent neural networks that implement a state of health estimating system for a vehicle 110. A state of health estimating system is a plurality of interconnected recurrent neural networks that gather information regarding vehicle components and can estimate a remaining useful life for one or more if the vehicle components. The recurrent neural networks can be interconnected in an acyclic tree structure of processing elements that mirrors the organization of vehicle systems, subsystems, and vehicle components. Training the acyclic tree structure of processing elements based on empirical vehicle data can determine which nodes of the acyclic tree will require recurrent neural networks and which nodes can be based on simpler logic. The acyclic tree structure of processing elements includes recurrent neural networks at nodes that input vehicle data and use memory to process time series data and that have been determined by training to contribute to estimates of vehicle remaining useful life. Nodes that do not use memory or process input vehicle data, for example nodes that combine outputs from lower level nodes in the tree, can be constructed using simpler logic elements, for example sum of product calculations, where one or more inputs are multiplied by weights and added. Thus, the present system advantageously conserves and increases efficiency of computing resources. Estimated useful life is defined as a percentage of time determined by comparing an estimated remaining useful lifetime for a vehicle component to an estimated useful lifetime for the vehicle component. The estimated useful lifetime is the amount of time that a vehicle component can be expected to operate in a vehicle prior to failure, or otherwise becoming unusable for its intended purpose, where intended purpose is defined based on the individual component. For example, battery failure can be defined by a battery no longer producing current at a rated voltage, while tire failure can be defined by a tire no longer producing a user determined amount of traction under user determined conditions.

A vehicle 110 can be described as a collection of interacting systems, for example powertrain, steering, braking, chassis, electrical, and chassis. Vehicle systems can in turn be described as a collection of interacting subsystems, for example a powertrain can include engine, transmission, transfer cases, and axels, etc. Each subsystem can be further described as a collection of other, intermediate subsystems and vehicle components, for example an engine can include pistons, valves, oil pumps, and fuel systems, etc. The remaining useful life estimates for each vehicle component can be combined into a remaining useful life for the vehicle subsystem to which it belongs and the remaining useful life estimates for the vehicle subsystems can be combined to provide a remaining useful life for the vehicle systems and ultimately for the vehicle 110 as a whole. The vehicle components can be combined based on estimates of their percentage contribution to the operation of the subsystems to which they belong. The subsystems can be combined based on estimates of their percentage contribution to the operation of the systems to which they belong.

A state of health and remaining useful life for a vehicle can be determined based on mileage for the vehicle. Determining a state of health and remaining useful life based on mileage can be unreliable because vehicles can experience operating conditions during their lifetimes that cause increased wear on one or more vehicle components and thereby decrease remaining useful life. For example, a vehicle can be used to haul heavy loads at low speed in an adverse environment such as a construction site where the air is full of dust and dirt. Vehicles can also undergo servicing including replacement of worn components that will increase the remaining useful life of the vehicle. Not all replacement components are equal, with original equipment manufacturer (OEM) replacement parts generally being of higher quality than aftermarket replacement parts and thereby corresponding to greater increases in remaining useful life. Determining a state of health estimate for a vehicle 110 that includes remaining useful life estimates for vehicle components can be improved by inputting data regarding the operation of a vehicle 110 to a plurality of recurrent neural networks combined with other processing nodes in an acyclic tree structure in a state of health estimating system that can analyze the vehicle component data over the lifetime of a vehicle to estimate remaining useful life of a vehicle, vehicle system, vehicle subsystems and vehicle components. The plurality of processing nodes including recurrent neural networks can be trained based on empirical data regarding vehicle wear and remaining useful life of vehicles and vehicle components. Training the state of health estimating system based on empirical data can determine which vehicle, engineering, service, and environmental data acquired over the lifetime of a vehicle will determine remaining useful life. Based on the training, the acyclic tree of processing nodes can determine weights that select data that is proven by the training process to be useful in estimating remaining useful life and ignore data that is irrelevant to the process. This permits the state of health estimating system to be organized in an efficient fashion, where memory is not wasted storing data that is not useful in estimating vehicle remaining useful life.

Training a state of health estimating system using empirical data permits determination of a vehicle optimization strategy that can be used by a computing device in a vehicle to maximize the remaining useful life of the vehicle 110 by avoiding wear-based vehicle component failure. The state of health estimating system is organized to mirror the organization of vehicle systems, subsystems, and components. Estimates for vehicle component remaining useful life are combined to form vehicle subsystems and weighted to determine the contribution of vehicle components to subsystems, subsystems to systems and systems to vehicles. The weights that combine the components, subsystems, and systems can be determined by training the state of health estimating system based on empirical data. Output from a state of health estimating system can be used to determine an optimization strategy to maximize the estimated remaining useful life for a vehicle. For example, wear-based vehicle component failure can be avoided by changing the operation of a vehicle 110 to use vehicle components with more remaining useful life in preference to vehicle components with less remaining useful life, in examples where a choice of two or more vehicle components with equivalent operation is possible. For example, a vehicle 110 can be made to reduce speed by braking, which causes wear on vehicle brake components, or by engine braking, where torque from a vehicle engine is applied to the drivetrain to slow the vehicle, which causes wear on vehicle drivetrain components.

The plurality of interconnected recurrent neural networks included in state of health estimating server 120 communicates with a computing device 115 in a vehicle 110, and other computing devices 115 via a wide area network 130 to gather data regarding the vehicle 110 including engineering test data, vehicle control data, vehicle service data, and vehicle environmental data. A server computer 120 can acquire vehicle control data, engineering test data, service data, and vehicle environmental data via data gathering software that communicates with vehicles, service centers, engineering labs and weather reporting stations, for example. Data gathering software can execute on a server computer 120 to gather data and pass it on to a cloud-based state of health estimating system using flexible transmission control protocol (FTCP) and in-vehicle transmission protocol (OVTP). FTCP and OVTP are software protocols that control the interchange of digital data over networks. Data gathering software can aggregate available data into smaller data structures using data statistics and data histograms to efficiently form the data into packets and provide a unified access point for a state of health estimating system. Each vehicle, service, engineering or environmental data source includes definitions of data to be pushed to the state of health estimating system including data structures and trigger events. Computing devices 115 in the vehicle, engineering, service and environmental data sources collect and process the data based on the defined data structures and, when a trigger event occurs, send the collected data to the state of health estimating system. Trigger events can be based on error codes generated by a vehicle 110 computing device 115, calendar dates, vehicle service events, or vehicle 110 mileage, for example.

Time series data including engineering test data, vehicle control data, vehicle service data, and vehicle environmental data can be input to a network of recurrent neural networks included in a state of health estimating system over the lifetime of a vehicle to determine estimated remaining useful life data for a vehicle, vehicle system, vehicle subsystems and vehicle components. The estimated remaining useful life data for each vehicle component can be combined to determine an estimated remaining useful life for the subsystems of a vehicle and the subsystems can be combined to determine an estimated remaining useful life for vehicle systems which can be combined to determine an estimated remaining useful life for a vehicle 110. In this example, the estimated remaining useful life of a vehicle subsystem can include vehicle components for which individual remaining useful life estimates may not been determined individually. In this example the useful remaining life for the subsystem can be estimated based on the estimates for the entire subsystem. The state of health estimating system can operate on a substantially continuous basis, where computing devices 115 corresponding to vehicle engineering laboratories, service facilities, environmental data centers and a vehicle 110 can upload data regarding vehicle operation periodically to the state of health estimating system via a server computer 120.

A computing device 115 in a vehicle 110 is in communication with a plurality of vehicle component controllers that include computing devices, for example, powertrain controller 112, brake controller 113 and steering controller 114 correspond to vehicle subsystems that each include a plurality of controllers that control vehicle components included in each subsystem. In addition, many other vehicle components have vehicle component controllers, including batteries, lighting, and sensors 116. These vehicle component controllers actuate vehicle components and acquire data regarding the operation of the vehicle components continuously as the vehicle operates. Vehicle component controllers can acquire a large volume of detailed data regarding vehicle components. To avoid overwhelming the cloud-based state of health estimating system with data, the computing device 115 can identify and transmit a subset of the vehicle component data it receives from vehicle component controllers. The subset of vehicle component data to be transmitted can be determined by vehicle manufacturers based on input from engineers that can determine which data should be transmitted to a state of health estimating system based on empirical studies of vehicle reliability.

The vehicle component data to be transmitted to the cloud-based state of health estimating system can be specified based on data deemed relevant to determining remaining useful life for a given vehicle component. For example, in an electric-powered vehicle 110, the high voltage battery pack can be a significant determinant of the overall remaining useful life of a vehicle. For example, the following data items can be used to determine the remaining useful life for a high-voltage battery pack:
Battery chemistry type
Battery cell size/connection type
Battery ambient temperature history including coolant temperature and individual battery cell temperature
Battery charging history including charge/discharge voltage/current profile, peak charging power and peak discharging power
Battery cell voltage and deviation from full charge
   Acquiring data regarding these items on a periodic basis and combining this data with empirically determined lifetime data for the particular battery type can permit a cloud-based state of health estimating system to estimate the remaining useful life for a given high-voltage battery.

As illustrated in this example, in addition to vehicle component controller data, a cloud-based state of health estimating system can use on be empirically determined from operation(s) of the vehicle components and vehicle subsystems in a given vehicle. The state of health estimating system can periodically upload new engineering test data as it is produced based on ongoing and/or updated empirical tests performed on vehicles and vehicle components in test environments and/or from empirical data from vehicles operating in the real world. Such data could be updated as deployed vehicles experience component failure in the field. The cloud-based state of health estimating system can be updated with new data on a regular basis to permit the system to benefit from the latest data. The updates can be accumulated, and the cloud-based state of health estimating system can be updated on a regular schedule, for example annually, to prevent the cloud-based state of health estimating system from confusing users by changing vehicle remaining useful life estimates too often.

Another source of data relevant to remaining useful component life is vehicle service data. Vehicle service data can include vehicle components being repaired or replaced. As a result of vehicle service, the remaining useful life of a component can be reset up to 100%, depending upon the type of service performed. For example, replacing vehicle components can reset the remaining useful life to 100% if original equipment manufacturer (OEM) recommended parts are used. In examples where aftermarket components that may not meet OEM standards are used, testing can be performed to verify the estimated useful lifetime of the components. Depending on the results of the component testing, e.g., durability, failure, material used, dimensions, etc., the remaining life of the part will be evaluated. For example, if a non-OEM (original equipment manufacturer) recommended part is used and is determined to have a life-rating equivalent to 60% of the OEM recommended part, the expected life algorithm can be adjusted to match. If these data are not available, or too cumbersome to gather, then a null value can be assigned, and an estimated component lifetime will not be available until further testing is performed. Failure rates for various components can be tracked by mileage, customer usage, and by geographic region to help determine failures in the field. Input from component failures will be uploaded to the cloud-based state of health estimating system and will help ensure an accurate life estimation is always used for each vehicle 110 using that component.

As a part of vehicle service data, wear-based monitoring can be determined for the cloud-based state of health estimating system by investigating system oil characteristics at regular maintenance intervals. Wear-based monitoring can investigate metal part-per-million (PPM) concentrations, types of metals, presence and concentration of water, fuel, and coolant in oil. Testing could be done for each vehicle or a smaller sample number of vehicles based on mileage, region, and type of use as can be determined from stored vehicle use data in the server computer 120. Determined oil analysis data can be fed to the cloud-based state of health estimating system via a client to adjust the wear compensation algorithms if necessary and be downloaded to manufacturers engineering laboratories to help in future vehicle development. Additional wear measurements can include system/subsystem/component disassembly to physically measure clearances of parts and to see how they correlate to expected clearances at specific expected life measurements.

Vehicle environmental data includes data regarding the environment in which a vehicle is operating and includes temperature, humidity, precipitation, etc. Environmental data can include other environmental factors such as smog, dust, and salt air such as occurs at sea-side locations. This data is available from commercially available weather reporting systems such as weather.com (The Weather Company, IBM corporation, Armonk, N.Y. 10504). Environmental data can also be gathered by sensors included in a vehicle 110 and transmitted to a state of health estimating system by a computing device 115 included in the vehicle 110. Environmental data can include data on atmospheric contaminants such as salt air, dust, acid rain, and smog which can influence vehicle component wear and thereby remaining useful life of vehicle components.

Data collected and sent over connectivity protocols as described above can be analyzed using a state of health estimating system to determine the overall remaining useful life of a vehicle 110. A state of health estimating system can predict the probability of failure for different components in a given vehicle 110 using as input data collected from the vehicle 110, engineering data that includes data collected from a plurality of vehicles, service data, and environmental data. Based on this overall health measure across different vehicles, the state of health estimating system can help vehicle buyers be informed when purchasing vehicles and vehicle owners be aware of the degradation of their vehicle through usage. The overall remaining useful life of a vehicle 110 can be used to determine a fair price for a used vehicle 110, or to determine when to repair or replace vehicle components, for example.

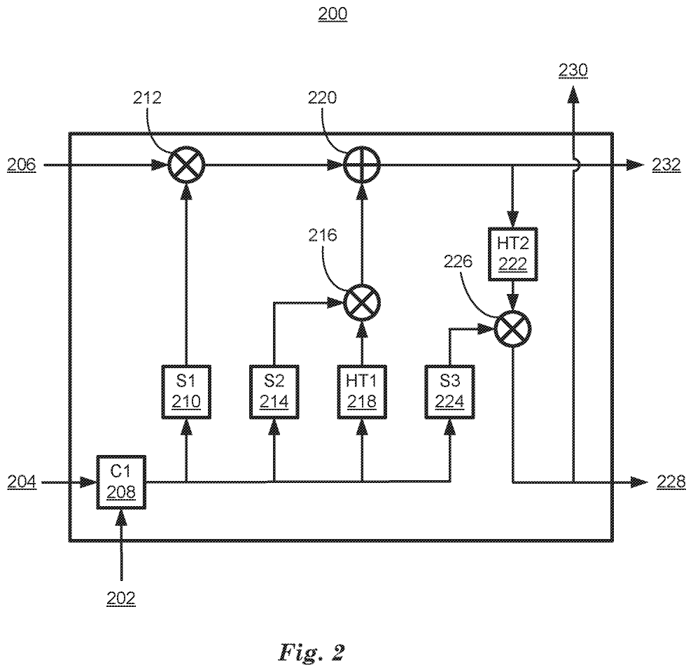

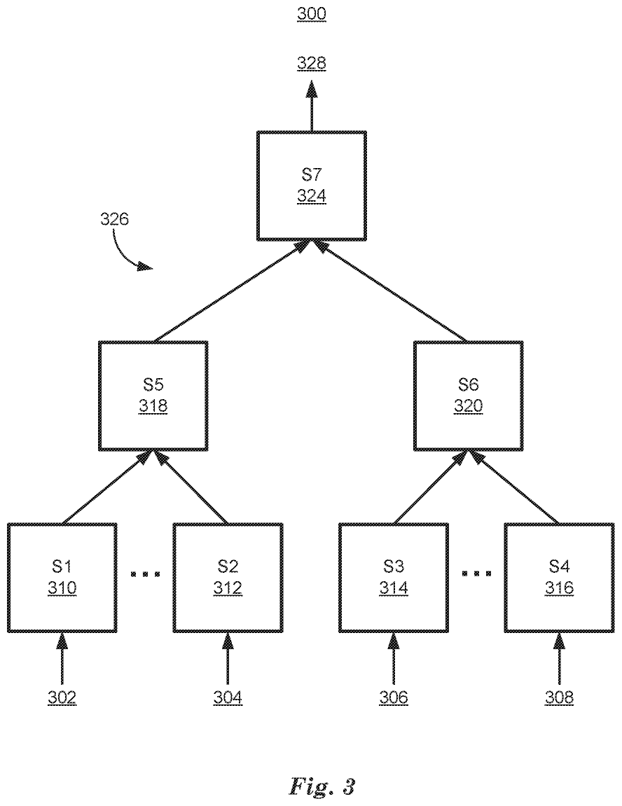

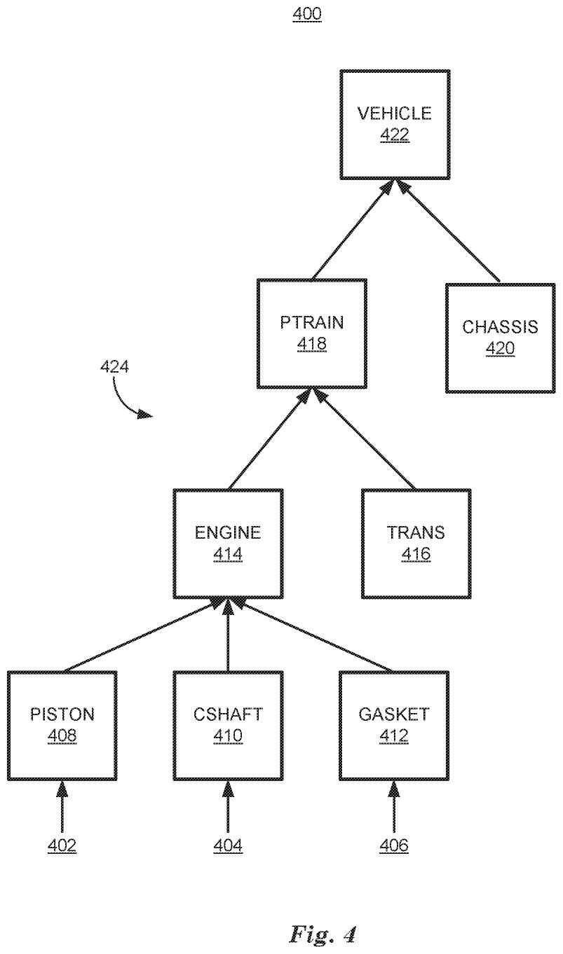

FIG. 2 is a diagram of a long short term memory (LSTM) recurrent neural network (RNN) 200. A vehicle state of health estimating system can include a network of LSTM-RNN 220 nodes as described in relation to FIGS. 3 and 4. An LSTM-RNN 200 is a type of neural network that improves the ability of a neural network to respond properly to long sequences of input data. A LSTM-RNN 200 includes gating elements including first, second and third multiply processes 212, 216, 226 as described below that permit an LSTM-RNN 200 to determine how much weight or importance to place on data from previous processing steps, whether to forget or gate data from the current processing step and whether to output the results of the current processing step or save the result until a later step. An LSTM-RNN 200 is a type of neural network that can be used to determine remaining useful life for vehicle components, subsystems, systems and a vehicle 110. An LSTM-RNN 200 is a type of neural network that includes memory configured to permit the LSTM-RNN 200 to recall results of previous steps and states corresponding to previous steps and thereby process time series data, where the result of a particular processing step is dependent upon previous processing steps. An example of this type of processing is natural language understanding, where the meaning of a particular word can be dependent upon the context, i.e. other words that come before or after the word. For example, in the sentence “Fruit flies like bananas, but time flies like an arrow” the phrase “flies like” has two different meanings, with the first occurrence being a noun-conjunction pair and the second occurrence being a verb-preposition pair. Natural language can be processed as time series data where each word is processed in the order in which it is encountered in written and spoken language. In this type of processing, which meaning to apply to each occurrence of the words “flies” and “like” can be determined by processing the other words before and after each occurrence of the words “flies” and “like”. A recurrent neural network includes memory and data paths to process time series data in a sequence of steps and combine previous results with current results and delay making decisions regarding each processing step until sufficient data is received to make a decision.

Processing vehicle data on a time sequence basis using an LSTM-RNN 200 improves prediction of component failures due to its ability to preserve sequential information in the network's state data and use this information to find correlations between events that are very far apart in time. Processing vehicle data having these types of long term dependencies using an LSTM-RNN 200 can improve determination of vehicle state of health because component failures can be spread apart very far in time with respect the life of a vehicle 110. The correlation between remaining useful life of vehicle components and vehicle data is not always immediate, e.g., abusing a vehicle 110 for a short period of time will not cause an immediate failure in most cases. Additionally, through use of an LSTM-RNN 200 that includes memory outside of the normal data flow of neural networks, an LSTM-RNN 200 networks can store, write, read, block, or pass data from a previous processing step to a subsequent processing step based on the data's value which can improve the ability to process certain inputs like metal content in oil, vehicle controller signals that set a diagnostic trouble code, like “sensor failure”, or hazardous vehicle operation like overheating, racing, etc. due to their detrimental effect on vehicle life, while not indicating an immediate failure. Processing vehicle data over the lifetime of a vehicle using a network of interconnected LSTM-RNN 200 nodes can improve the ability of a vehicle state of health system to accurately predict vehicle component failure by determining estimated remaining useful life data for vehicle components, subsystems, systems, and the vehicle 110 as a whole.

LSTM-RNN 200 begins processing by inputting current input data xₜ 202 for the current processing step t. Current input data xₜ 202 can include vehicle data output by a computing device 115 in a vehicle 110 regarding the status of a vehicle component, engineering data, service data or environmental data. Inputting vehicle data to an LSTM-RNN 200 over the lifetime of a vehicle 110 can improve the ability of a vehicle state of health system to accurately estimate remaining useful life by determining which input data is relevant to determination of vehicle component remaining useful lifetime calculations and storing state data corresponding to the input data for future calculations. An LSTM-RNN 200 can be trained using empirically determined data regarding vehicle component wear data and subsequent remaining useful lifetime data to automatically determine which the manner in which input vehicle data will determine vehicle component remaining useful lifetime estimates. The following explanation of LSTM-RNN 200 node operation describes the manner in which vehicle data in the form of current time step input data xₜ 202 is combined with previous time step output data hₜ₋₁ 204 and previous time step cell state Cₜ₋₁ 206 to determine an estimate of remaining useful lifetime for a vehicle component in the form of current time step output data hₜ 230.

Current input data xₜ 202 is input to concatenate process (C1) 208 to concatenate the current input data xₜ 202 with previous step output data hₜ₋₁ 204 to form concatenated vector [hₜ₋₁, xₜ]. Previous step output data hₜ₋₁ 204 can be stored in and recalled from memory after being output by the LSTM-RNN 200 during a previous processing step. Concatenated vector [hₜ₋₁, xₜ] is input to a sigmoid process (S1) 210, which calculates a “forgetting” function ƒₜ according to the equation:

ƒₜ=σ(W_{ƒ}·[hₜ₋₁,xₜ]+b_{ƒ}) (1)

In equation (1), σ is a sigmoid function that maps the results of weighting and biasing the concatenated vector [hₜ₋₁, xₜ] into the range [0,1], W_{ƒ} is a forgetting weight determined by training the LSTM-RNN 200, and b_{ƒ} is a forgetting bias factor also determined by training. The output from sigmoid processing 210 is output to a first multiply process 212 that multiplies the output from sigmoid processing 210 applied to a previous step cell state Cₜ₋₁ 206 to form a second concatenated vector [hₜ₋₁, xₜ]. Previous step cell state Cₜ₋₁ 206 is recalled from memory after being output and stored by a previous step of the LSTM-RNN 200.

The second concatenated vector [hₜ₋₁, xₜ] is input to a second sigmoid process (S2) 214 which calculates an input function iₜ for time step t according to the equation:

iₜ=σ(Wᵢ·[hₜ₋₁,xₜ]+bᵢ) (2)

Where, as in equation (1), a is a sigmoid function that maps the results of weighting and biasing the second concatenated vector [hₜ₋₁, xₜ] into the range [0,1] and Wᵢ is an input weight and bᵢ is an input bias both determined by training the LSTM-RNN 200. The second concatenated vector [hₜ₋₁,xₜ] is also input to a first hyperbolic tangent process (HT1) 218 which calculates a hyperbolic tangent \tilde{C}ᵢ of the weighted and biased second concatenated vector [hₜ₋₁,xₜ] according to the equation:

\tilde{C}ₜ=tan h(W_{c}·[hₜ₋₁,xₜ]+b_{c}) (3)

Where the hyperbolic tangent maps the weighted and biased second concatenated vector[hₜ₋₁,xₜ] onto the range [0,1] and the weight W_{c} and bias b_{c} are determined by training the LSTM-RNN 200. The results of sigmoid process 214 and first hyperbolic tangent process 218 are combined by a second multiply process 216.

The results of first multiply process 212 and second multiply process 216 are combined at adder 220 to form the current cell state Cₜ:

Cₜ=ƒₜ*Cₜ₋₁+iₜ*\tilde{C}ₜ (4)

Current cell state is output to memory 232 to be stored and recalled for processing in subsequent processing steps and input to second hyperbolic tangent process (HT2) 222 which calculates the hyperbolic tangent of the current cell state tan h(Cₜ). The concatenated vector [hₜ₋₁, xₜ] is also input to a third sigmoid process which calculates a raw output value oₜ according to the equation:

oₜ=σ(Wₒ·[hₜ₋₁,xₜ]+bₒ) (5)

Where, as in equations (1) and (2), σ is a sigmoid function that maps the results of weighting and biasing the second concatenated vector [hₜ₋₁,xₜ] into the range [0,1] and Wₒ is an output weight and bₒ is an output bias both determined by training the LSTM-RNN 200. A third multiply process 226 combines the output from second hyperbolic tangent process 222 and third sigmoid process 224 to form current step output data hₜ:

hₜ=oₜ*tan h(Cₜ) (6)

Which is output as the current step output data hₜ 230 and stored 228 to memory to be recalled at subsequent processing steps. As illustrated in FIG. 2, LSTM-RNN 200 processing can, with the addition of memory, permit an LSTM-RNN 200 to process current input data xₜ 202 along with previous step output data hₜ₋₁ and previous step cell state Cₜ₋₁ 206 to generate current step current step output data hₜ. In this fashion an LSTM-RNN 200 neural network can process current data from a time sequence of data while responding to previously processed data from the time sequence.

FIG. 3 is an example diagram of a state of health estimating system 300. The state of health estimating system 300 is a hierarchical network of connected of LSTM-RNN 200 processing subnetworks (S1, S2, S3, S4, S5, S6, S7) 310,312, 314, 316, 318, 320, 322, collectively subnetworks 324, arranged in the form of an acyclic graph such as a tree. The subnetworks 324 within the graph can be as simple as single neurons, for example to calculate overall health measure for any given vehicle based on inputs from a lower level of the graph, or as complex as a plurality of LSTM-RNN 200 nodes. Subnetworks 324 that input vehicle, engineering, service, and environmental data, along with processed data from a lower level in the tree structure can require an LSTM-RNN 200 node to process and store cell state data regarding vehicle component remaining useful lifetime, for example. Subnetwork nodes 324 that input remaining lifetime estimates from one or more subnetwork nodes 324 and perform simple arithmetic calculations to weight, add, and scale results from other subnetwork 324 nodes can be simpler nodes, for example. The arrangement of subnetworks 324 corresponds to the arrangement of vehicle components, subsystems and systems in a vehicle 110 as will be illustrated in FIG. 4, discussed below.

Determination of remaining useful life for a vehicle 110 and vehicle components begins by inputting vehicle data 302, 304, 306, 308 to input layer subnetworks 310, 312, 314, 316. Input layer subnetworks 310, 312, 314, 316 can include a plurality of subnetworks 324, where the number of subnetworks 234 is determined by the number of vehicle components input to state of health estimating system 300. Vehicle data 302, 304, 306, 308 can include engineering test data, vehicle control data, vehicle service data, and vehicle environmental data related to a single vehicle component or vehicle subsystem, where the number of vehicle data 302, 304, 306, 308 inputs is determined by the number of vehicle components to process. Measured and calculated vehicle control data inputs can indicate vehicle 110 operating conditions, for example. Vehicle environmental data can include location in terms of region, i.e. vehicle location close to a beach or in a salted area during winter, etc., and environmental conditions during use including weather and atmospheric contaminants. Vehicle data 302, 304, 306, 308 inputs can include vehicle engineering data including component failure rates by region/mileage/usage patterns, resultant wear patterns from vehicle durability/vehicle testing and component/subsystem/system wear based computer models. Vehicle data 302, 304, 306, 308 inputs can further include vehicle service data including component wear measurements based on inspection and fluid properties from dealership/fleet testing. Vehicle data 302, 304, 306, 308 inputs can include previously determined data from customer-owned vehicle status and component/subsystem/system failures and usage data from similar vehicles determined by previous processing of vehicle data by state of health estimating systems 300.

Although the diagram for state of health estimating system 300 illustrates three layers of subnetworks 326, in practice a state of health estimating system 300 can include a plurality of layers. Each vehicle 110 can have an instance of a state of health estimating system 300. The number of inputs for vehicle data 302, 304, 306, 308 and input layer subnetworks 310, 312, 314, 316 would depend upon the number of vehicle components and subsystems to be processed. LSTM-RNNs 200 can be used in the input layer of subnetworks 310, 312, 314, 316 to input and process vehicle component, engineering, service and environmental data. Subnetwork 326 types for layers above the input layer will be determined as appropriate to ensure optimal and robust fitting. For example, input layers and intermediate layers that require time sequence inputs can use LSTM-RNNs 200. Intermediate layer subnetworks 326 that input vehicle component remaining useful life values from lower level subnetworks 326 without time sequence data can be simpler neural networks. The number of layers of subnetworks 326 can be determined based on the subnetwork's 326 ability to recognize usage, wear, and failure patterns from vehicle use and testing without overfitting, where overfitting is defined by a neural network being trained to properly classify training data but failing to classify new data properly. Overfitting can be avoided by dividing the training data into three equally-sized and separate subsets. A first subset can be used for training, a second subset can be used for validation, where the results of processing the second subset are used to validate or invalidate hypotheses regarding the neural networks operation, and the third subset is used to rate the performance of the trained neural network.

FIG. 4 is an example state of health processing system 400 for a portion of the vehicle components, subsystems, and systems included in a vehicle 110. The portion of vehicle components, subsystems, and systems included in a vehicle 110 are also illustrated in Table 1. State of health processing system 400 includes first layer vehicle component subnetworks (PISTON, CSHAFT, GASKET) 408, 410, 412 corresponding to LSTM-RNNs 200 that input vehicle data 402, 404, 406, respectively. A portion of vehicle data 402, 404, 406 input to first layer vehicle component subnetworks 408, 410, 412 described in Table 1 entries 1.1.1.1, 1.1.1.2, and 1.1.1.3. Remaining useful life data are determined by first layer vehicle component subnetworks 408, 410, 412 as described in Table 1 entries 1.1.1.4, 1.1.1.5, and 1.1.16 and output by first layer vehicle component subnetworks 408, 410, 412 as input to an LSTM-RNN 200 labeled engine subnetwork (ENGINE) 414, to be combined with other vehicle, engineering, service and environmental data to form an overall estimate of engine remaining useful life as illustrated in Table 1 entries 1.1.1.7 and 1.1.2. Remaining useful life data output by engine subnetwork 414 can be combined with transmission subsystem remaining useful life data (Table 1, entry 1.2) output by transmission subnetwork (TRANS) 414 and other powertrain subsystems outputs by powertrain subnetwork (PTRAIN) 418 to form an overall remaining useful life estimate for a vehicle powertrain as illustrated by Table 1 entry 1.3. Estimated remaining useful life data for a vehicle powertrain system can be combined with estimated chassis system remaining useful life data (Table 1, entries 1.4, 1.4.1) output by a chassis subnetwork (CHASSIS) 420 and other vehicle systems by vehicle subnetwork (VEHICLE) 412 to form overall vehicle remaining useful life data (Table 1, entry 2) for the vehicle 110. Remaining useful life data for vehicle components, subsystems, systems and a complete vehicle 110 are normalized on a 0-100% basis based on expected remaining life.

Table 1 includes example calculations for remaining useful life for a vehicle based on RMS values for remaining useful life calculated by state of health estimating system 400 and can be output by state of health estimating system 400 as intermediate values and an overall value for the vehicle 110.

TABLE 1
Vehicle Remaining Useful Life Example

1. System = Powertrain
1.1. Subsystem = Engine

1.1.1. Vehicle Components = piston, crankshaft, head gaskets

1.1.1.1. Related drive metrics = engine coolant temperature, engine

speed, engine torque, ambient temperature, boost levels

1.1.1.2. Related maintenance metrics = oil change interval, % fuel

in oil, % water in oil

1.1.1.3. Highest wear patterns of engine are more related to high

```
    boost levels, at low engine speed, at cold engine temperatures,
    mileage = 150K miles
```

1.1.1.4. Crankshaft remaining life = 47%

1.1.1.4.1. Weight for engine subsystem life = 0.4

1.1.1.5. Piston remaining life = 62%

1.1.1.5.1. Weight for engine subsystem life = 0.2

1.1.1.6. Head Gasket remaining life = 31%

1.1.1.6.1. Weight for engine subsystem life = 0.4

1.1.1.7. Engine Life = (0.4)(0.47) + (0.2)(0.62) + (0.4)(0.31) =

43.6%

1.1.2. Weight for engine system life = 0.5

1.2. Transmission Life = 60%

1.2.1. Weight for transmission system life = 0.5

```
  1.3. Powertrain life = (0.5)(0.60) + (0.5)(.436) = 51.8%
  1.4. Chassis life = 70%
```

1.4.1 Weight for chassis life = 0.5

2. Vehicle Life = (0.7)(0.5) + (0.5)(.518) = 61%

Outputs from the state of health estimating system 400 include outputs for remaining useful life for vehicle subsystems, system and major vehicle components in addition to an overall remaining useful life for the vehicle 110. The systems of interest in a vehicle 110 include but are not limited to the powertrain, chassis, electrical system, and the vehicle body or exterior. Subsystems are categories defined within each respective system. For example, the subsystems within powertrain for a vehicle 110 can include engine, transmission, transfer case, rear differential, front differential, and front/rear driveshafts. For a hybrid vehicle 110, a state of health estimating system could have processing subnetworks 326 for both an internal combustion motor and an electric motor, where the network would include a hierarchy that includes components for the engine and transmission and components for the high voltage battery and electric drive. Monitoring the state of health of components within an engine would indicate the engine state of health as a whole and would include pistons, camshaft, crankshaft, connecting rods, valve guides, main and rods bearings, etc. Determining the state of health of engine components can depend upon engineering data including wear factors and life simulation which will be used to calculate damage scores. Wear factor and life simulations can be determined by creating models and correlating them with empirical test data.

A subsystem's remaining useful life value can be determined by the state of health estimating system 400 based on the vehicle status, updated and stored in a computing device 115 in the vehicle 110 and uploaded to a state of health estimating system 400 periodically. A subsystem's remaining useful life can be based on assumed damage for each component at the specific operating condition reported by the vehicle 110. The damage will be combined and stored over the useful life of the vehicle and will be compared against the estimated health each component/subsystem/system/vehicle. The damage scores are calculated as root-mean-square (RMS) values. RMS values skew the values higher when there is a single high value. This is desirable, as the overall state of health of a vehicle 110 is most accurately based on the least healthy sub-system.

A state of health estimating system 400 as discussed herein improves the efficiency and accuracy of estimating remaining useful life of a vehicle 110 by using as inputs real time customer usage, empirically measured failure rates by region/mileage/use, manufacturer's durability/vehicle testing. A state of health estimating system 400 that includes LTSM-RNN 200 neural networks as subnetworks 424 can be trained to determine correlations between inputs (damage and health comparisons) and vehicle, vehicle system, vehicle subsystems, and vehicle component remaining useful life based on wear-based vehicle calibration. The state of health estimating system 400 can be configured based on results of training to ignore vehicle data that does not contribute to estimates of overall vehicle remaining useful life. Vehicle data that does not contribute to estimates of overall remaining useful life can be deleted from data to be input to the state of health system and thereby reduce network traffic, conserving bandwidth and/or providing network resources to be otherwise available. Ignoring irrelevant vehicle data can also include not saving LTSM-RNN 200 outputs and cell states when the output is determined to not contribute to overall estimates of vehicle health and deleting entire LTSM-RNN 200 processing nodes that do not contribute to estimates of overall remaining useful life and thereby saving processing time and memory. Wear-based vehicle calibration includes inputting data regarding real world component failure rates to determine vehicle 110 expected useful life. Training state of health estimating system 400 includes comparing backpropagated results from each subnetwork 424 and comparing the backpropagated results to ground truth determined by empirical data regarding remaining useful life. Empirical data regarding remaining useful life can be determined by real world studies of vehicle component wear and vehicle component failure. As a result, the state of health estimating system 400 can model factors relating to the environment and unpredictable customer usage which might not be foreseen during prototype testing by the manufacturer.

Remaining useful life data output from a state of health estimating system 400 can be used as input to a vehicle optimization strategy. A vehicle optimization strategy can maximize the remaining useful life of a vehicle 110 by operating the components and subsystems of a vehicle 110 based on the remaining useful lives of the components and subsystems and recommending replacement or repair of components nearing the end of their useful life. For example, a state of health estimating system 300 could give recommendations for which components and seals should be replaced to ensure extended life, such as turbo seals on a low mileage late model diesel engine. A state of health estimating system 400 could predict when a component's remaining useful life reaches a user-determined lower limit, for example below 20%, where an optimization strategy could include recommending replacing or inspecting the component to avoid being stranded or a major malfunction that could lead to more damage and downtime.

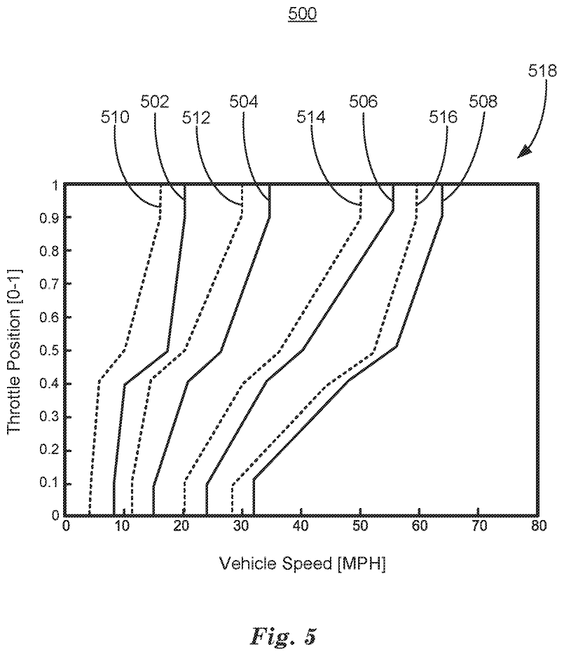

FIG. 5 is a diagram of a shift map 500 that illustrates a vehicle optimization strategy determined based on component remaining useful life data output by a state of health estimating system 500. A shift map 500 is an illustration of data included in a computing device 115 that can be used by computing device 115 to determine when to up and downshift an automatic transmission. A vehicle optimization strategy related to automatic transmission shifting can modify a shift map 500 to compensate for wear that results in decreased remaining useful life on one or more transmission gears. A shift map 400 graphs, for various vehicle gears, throttle position (Y-axis) on a 0 (no throttle) to 1 (full throttle) scale versus vehicle speed in miles per hour on the X-axis. The shift lines for first gear 402, second gear 404, third gear 406 and fourth gear 408 indicate when an automatic transmission should upshift to a higher gear when accelerating and when to downshift when deaccelerating based on the vehicle's throttle position and speed. In this example a state of health estimating system has determined that first gear is experiencing low remaining useful life due to high engine torque and harsh environmental conditions, for example a diesel engine truck hauling heavy loads at low speeds.

A computing device 115 in the vehicle 110, upon downloading component remaining useful life data from a state of health estimating system 400 indicating that first gear components in a vehicle transmission is experiencing excessive wear and has a shortened estimated remaining useful life, can determine an optimization strategy for shifting gears in a vehicle 110. The optimization strategy includes changing the shift map 500 data to change the shift lines to new first gear 510, new second gear 512, new third gear 514 and new fourth gear 516, collectively new shift lines 518 (dashed lines). The new shift map 500 data can be determined by a state of health estimating system 400 and downloaded to a computing device 115 in a vehicle 110, or the estimated remaining useful life data regarding transmission gears in a vehicle 110 can be downloaded and a computing device 115 in the vehicle 110 can determine the optimization strategy. In either example, the optimization strategy can be used to operate a vehicle by communicating the optimization strategy including a shift map 500 including new shift lines 518 to a transmission controller in the vehicle 110 to cause the transmission to use the new shift lines 518 when shifting gears. By shifting from first gear to second gear at lower speeds, wear on first gear is reduced at the cost of increasing wear on second gear, which has a longer remaining useful life. Shift points for third and fourth gears are also changed to distribute the increased wear more evenly among the gears. In this fashion, a vehicle 110 can dynamically adjust to changes in remaining useful life of components and delay necessary transmission service and prolong the remaining useful life of the vehicle 110 as a whole. Computing device 115 can alert a user that this dynamic adjustment is taking place and give the user an ability to opt-out of the change in examples where the proposed change will reduce performance or drivability to unacceptable levels. In this example the user can be alerted as to when transmission service will be required by the determined reduced remaining useful life of first gear.

Another example is a high voltage battery pack included in a full hybrid electric vehicle (FHEV). The expected useful life of this vehicle 110 can be up to 280,000 miles. In these types of vehicle, the remaining useful life of the high voltage battery pack is an important determinant of the remaining useful life of the vehicle 110. A vehicle optimization strategy can adjust battery usage dynamically based on measured battery usage and degradation to prolong the battery life. For example, if the degradation of the battery affects the charging and discharging power, then fewer charge/discharge cycles may be enabled, or the charging and discharging power limit can be reduced and thereby reduce the stress on the battery. In another example, if a state of health estimating system 300 determines that there is an un-balanced cell-aging scenario, i.e., one or more cells are aging more rapidly than the rest of the battery cells, the battery controller can adjust the battery operation range and implement a battery cell balancing strategy to account for the unbalanced cell, where battery cells with more remaining useful life are used rather than battery cells with less remaining useful life. Overall, all these strategy update could extend the life of the system and thereby the vehicle 110, while having minimal impact on the user.

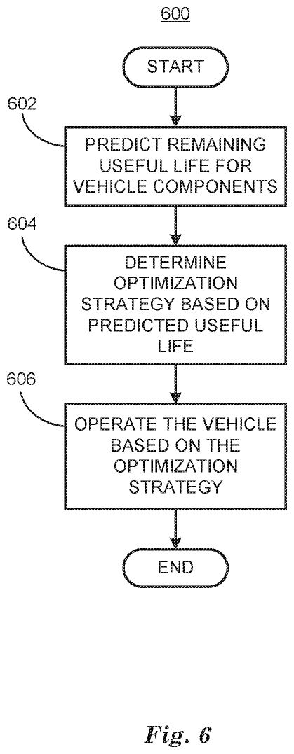

FIG. 6 is a diagram of a flowchart, described in relation to FIGS. 1-4, of a process 600 for operating a vehicle based on a vehicle 110 optimization strategy, where an optimization strategy is a plan for increasing the estimated useful life of vehicle components and thereby increasing the estimated useful life of a vehicle 110 by operating the vehicle 110 in a manner that preferentially uses vehicle components with greater estimated remaining useful life based on estimated remaining useful life data output by a state of health estimating system 400. Process 600 can be implemented by a processor of computing device, taking as input information from sensors, and executing commands, and outputting object information, for example. Process 600 includes multiple blocks that can be executed in the illustrated order. Process 600 could alternatively or additionally include fewer blocks or can include the blocks executed in different orders.

Process 600 begins at block 602, where a state of health estimating system 400 predicts component failure based on estimating remaining useful life for vehicle components, subsystems, systems, and the vehicle 110 itself by inputting vehicle control data, vehicle engineering data, vehicle service data, and vehicle environmental data. These data are processed using a state of health estimating system 400 that includes a hierarchical system of LSTM-RNN 200 processing nodes as described in relation to FIGS. 2-4. The state of health estimating system 400 outputs remaining useful life data for vehicle components, subsystems, systems, and the vehicle 110 itself.

At block 604 an optimization strategy for the vehicle 110 is determined based on the remaining useful life data output by the state of health estimating system 400 as discussed in relation to FIG. 5. The optimization strategy can be determined by a cloud-based server computer 120 and downloaded to a computing device 115 in a vehicle 110, or the remaining useful life data can be downloaded to a computing device 115 in a vehicle and the optimization strategy determined by the computing device 115 or a combination of both.

At block 606 the vehicle 110 can operate by using a computing device 115 to control vehicle components including powertrain, steering and brakes via controllers 112, 113, 114 to operate vehicle 110 according to the optimization strategy. Following block 606 process 600 ends.

Computing devices such as those discussed herein generally each include commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (e.g., a microprocessor) receives commands, e.g., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium includes any medium that participates in providing data (e.g., commands), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A computer, comprising:
a processor; and
a memory, the memory including instructions executable by the processor to:
predict one or more failures for each of a plurality of vehicle components by processing vehicle data with one or more recurrent neural networks, wherein the vehicle data includes engineering test data, vehicle control data, vehicle service data, and vehicle environmental data, and wherein predicting the respective failures includes determining a remaining useful life for each of the plurality of vehicle components;
determine a vehicle optimization strategy by optimizing the remaining useful life for one or more of the plurality of vehicle components to avoid the respective failures; and
download the vehicle optimization strategy to a vehicle.

2. The computer of claim 1, the instructions including further instructions to process the vehicle data by uploading the vehicle control data and the vehicle environmental data to a cloud-based computing device with a computing device included in the vehicle.

3. The computer of claim 1, wherein the vehicle optimization strategy includes determining the vehicle control data that avoids the failures by operating the vehicle based on one or more of the plurality of vehicle components with the most remaining useful life.

4. The computer of claim 3, wherein operating the vehicle based on the vehicle components with the most remaining useful life includes one or more of, when two or more battery cells can be used to operate the vehicle, selecting a battery cell with the fewest charge/discharge cycles for operating the vehicle or, when two or more transmission gears can be selected for operating the vehicle, selecting a transmission gear with the least wear.

5. The computer of claim 1, the instructions including further instructions to operate the vehicle based on vehicle optimization strategy by downloading the vehicle control data from a cloud-based computing device.

6. The computer of claim 1, wherein the engineering test data includes component wear data based on empirical testing of one or more of the plurality of vehicle components.

7. The computer of claim 1, wherein the vehicle service data includes data regarding repairs and routine maintenance performed on the vehicle including measurements of one or more of vehicle component wear and vehicle component replacement.

8. The computer of claim 7, wherein the measurements of the vehicle component wear includes vehicle fluid analysis, including vehicle oil analysis.

9. The computer of claim 1, wherein the vehicle control data includes operating data for one or more of the vehicle components acquired by a computing device included in the vehicle, wherein the operating data includes data acquired by sensors included in the vehicle.

10. The computer of claim 1, wherein the vehicle environmental data includes data regarding vehicle operating conditions acquired by a computing device included in the vehicle, wherein vehicle operating conditions includes data acquired by sensor included in the vehicle.

11. The computer of claim 1, wherein the one or more recurrent neural networks includes a tree structure of recurrent neural networks, wherein vehicle component subsystems each have a separate recurrent neural network that calculates the remaining useful life for each vehicle component subsystem.

12. The computer of claim 1, the instructions including further instructions to operate the vehicle based on the downloaded vehicle optimization strategy.

13. A method, comprising:
predicting one or more failures for each of a plurality of vehicle components by processing vehicle data with one or more recurrent neural networks, wherein the vehicle data includes engineering test data, vehicle control data, vehicle service data, and vehicle environmental data and wherein predicting the respective failures includes determining a remaining useful life for each of the plurality of vehicle components;
determining a vehicle optimization strategy by optimizing the remaining useful life for one or more of the plurality of vehicle components to avoid the respective failures; and
downloading the vehicle optimization strategy to a vehicle.

14. The method of claim 13, further comprising processing the vehicle data by uploading the vehicle control data and the vehicle environmental data to a cloud-based computing device with a computing device included in the vehicle.

15. The method of claim 13, wherein the vehicle optimization strategy includes determining the vehicle control data that avoids the failures by operating the vehicle based on one or more of the plurality of vehicle components with the most remaining useful life.

16. The method of claim 15, wherein operating the vehicle based the vehicle components with the most remaining useful life includes one or more of selecting battery cells with the fewest charge/discharge cycles for operating the vehicle or, when two or more transmission gears can be selected for operating the vehicle, selecting the transmission gear with the least wear.

17. The method of claim 13, further comprising operating the vehicle based on vehicle optimization strategy by downloading the vehicle control data from a cloud-based computing device.

18. The method of claim 13, wherein the engineering test data includes component wear data based on empirical testing of one or more of the plurality of vehicle components.

19. The method of claim 13, wherein the vehicle service data includes data regarding repairs and routine maintenance performed on the vehicle including measurements of one or more of vehicle component wear and vehicle component replacement.

20. The method of claim 19, wherein the measurements of the vehicle component wear includes vehicle fluid analysis, including vehicle oil analysis.
